(19) United States
(12) Patent Application Publication
(10) Pub. No.: US 2022/0378069 A1
(43) Pub. Date: Dec. 1, 2022

(54) QUICK-COOKING NOODLE STRUCTURE

(71) Applicant: A-SHA REPUBLIC INC., Tapei City (TW)

(72) Inventor: TA-WEI LO, TAIPEI CITY (TW)

(21) Appl. No.: 17/330,426

(22) Filed: May 26, 2021

(51) Int. Cl. A23L 7/109

(52) U.S. Cl. CPC A23L 7/109

(57) ABSTRACT

A quick-cooking noodle structure includes a noodle body and at least one convex rib, wherein the noodle body is strip-shaped and flat; the convex rib is configured on one surface of the noodle body along a long side of the noodle body; a width of the convex rib is equal to a width of the noodle body on each of both sides of the convex rib, and a height of the convex rib is equal to a height of the noodle body, thereby allowing the noodle body to generate wrinkles and wavy lines when the noodle body is dried to a quick-cooking noodle, making cooking time of the quick-cooking noodle shorten, increasing cooked noodle bite texture, and further allowing soup or seasoning to attach to the wrinkles and wavy lines, so as to add flavor to the noodles.

### TECHNICAL FIELD OF THE INVENTION

The present invention relates to a quick-cooking noodle structure, and more particularly to a quick-cooking noodle structure that can shorten noodle cooking time and increase bite texture when the noodles are cooked and eaten.

### DESCRIPTION OF THE PRIOR ART

Noodles are the main food besides rice in our daily life because of their easy cooking, requiring no complicated cooking skills and capable of being eaten in a short time. Especially, there are quite a variety of instant noodles in the existing market, which can be prepared in simple and fast cooking process, so they are popular with consumers.

However, the existing noodles have various thicknesses in pursuit of different tastes. As shown in FIG. 1, the rectangular noodle 1 is set to a thicker thickness, or as shown in FIG. 2, the round noodle 2 is set to a larger diameter, and whether it is thicker flat noodles or thicker rounded round noodles, it is mainly for the pursuit of different texture (commonly known as chewiness, so that the noodles have more bite). Although these noodles can meet the taste needs of consumers, they relatively make the internal cooked time of the noodle longer than the outside of the noodle upon cooking, which causes the noodle to be difficult to be fully cooked, and thus making the cooking time unable to be shortened. However, if the cooking time is too long, it may cause the noodles to be too soft and have no texture (chewiness), making the taste of the noodles and cooking time unable to balance, which may affect the sales of products for the fast-paced modem life.

### SUMMARY OF THE INVENTION

The main object of the present invention is to provide a quick-cooking noodle structure, making noodle cooking time shortened, and cooked noodle bite texture increased when eating.

To achieve the above object, the present invention proposes a quick-cooking noodle structure, including a noodle body and at least one convex rib, wherein the noodle body is strip-shaped and flat; the convex rib is configured on one surface of the noodle body along a long side of the noodle body; a width of the convex rib is equal to a width of the noodle body on each of both sides of the convex rib, and a height of the convex rib is equal to a height of the noodle body, thereby allowing the noodle body to generate wrinkles and wavy lines when the noodle body is dried to a quick-cooking noodle, making cooking time of the quick-cooking noodle shorten, increasing cooked noodle bite texture, and further allowing soup or seasoning to attach to the wrinkles and wavy lines, so as to add flavor to the noodles.

According to the quick-cooking noodle structure mentioned above, a width of the convex rib is set to 1 mm, and a width of the noodle body on each of the both sides of the convex rib 1 mm, which is the best.

According to the quick-cooking structure mentioned above, a height the convex rib is set to 0.6 mm, and a height of the noodle body 0.6 mm, which is the best.

### BRIEF DESCRIPTION OF THE DRAWINGS

FIGS. 1 and 2 respectively are a perspective view of a conventional noodle;

FIG. 3 is a perspective view of noodles formed by extrusion molding according to the present invention;

FIG. 4 is a perspective view of the present invention;

FIG. 5 is a cross-sectional view of the present invention; and

FIG. 6 is a perspective view of a quick-cooking noodle made after drying according to the present invention.

### DETAILED DESCRIPTION OF THE PREFERRED EMBODIMENTS

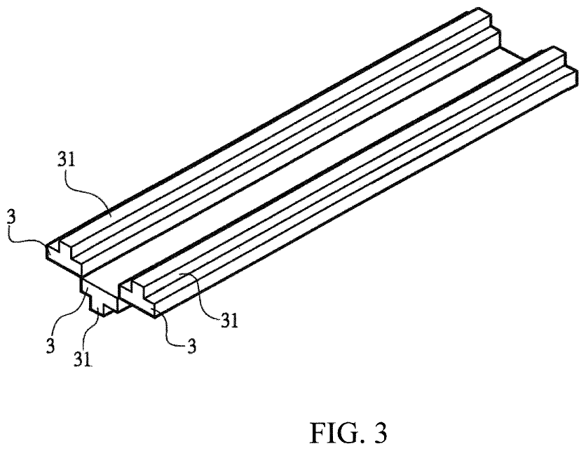

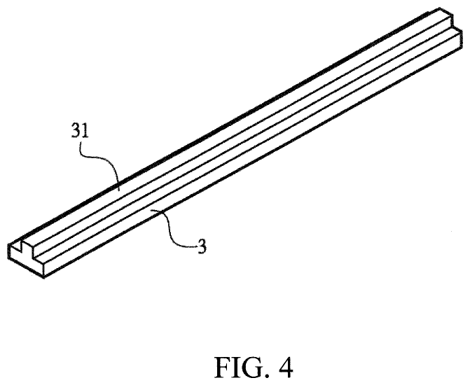

Referring to FIGS. 3 and 4, a quick-cooking noodle structure of the present invention includes a noodle body 3 and at least one convex rib 31, where the noodle body 3 is formed by means of extrusion molding, being a flat strip structure with the convex rib 31. In a preferred embodiment, the formed noodle body 3 is arranged in a continuous top-down reverse direction to form a majority of noodle bodies 3 as FIG. 3 shows.

The convex rib 31 is configured on one surface of the noodle body 2 along the long side of the noodle body 3, where the width of the convex rib 31 is equal to the width of the noodle body 3 on each of the both sides of the convex rib 31, and the height of the convex rib 31 is equal to the height of the noodle body 3.

With the above structure, when the noodle bodies are dried into quick-cooking noodles, they are wrinkled and wavy, changing to another shape, making each of them form a multi-angle heating area when cooking, and further allowing the cooking time of the fast-cooking noodles to be shortened and allowing them to be fully cooked. Furthermore, the bite texture (chewiness) of the fully-cooked noodles can be increased, and the soup or seasoning can attach to the wrinkles and wavy lines to add flavor to the noodles.

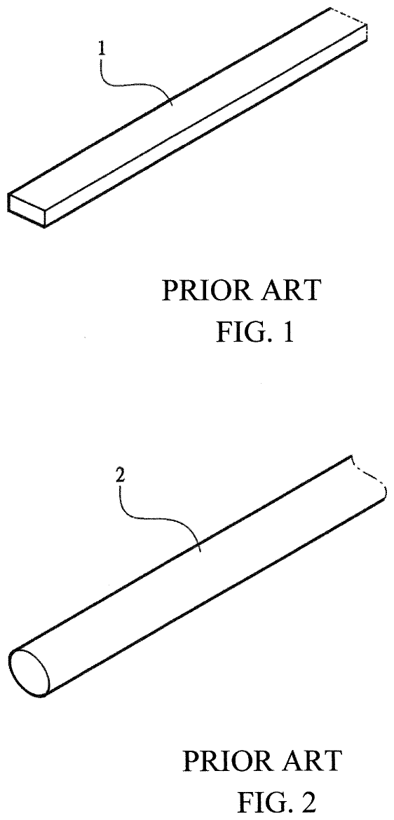

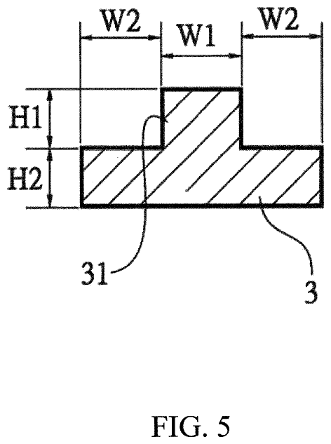

Referring to FIG. 5, the width of the convex rib 31 of the present invention is equal to the one of the noodle body 3 on each of the both sides of the convex rib 3, and the height of the convex rib 31 is equal to the height of the noodle body 3. In the embodiment, the width W1 of the convex rib 31 is set to 1 mm, and the width W2 of the noodle body 3 on each of the both sides of the convex rib 31 1 mm, which is the best; the height H1 of the convex rib 31 and the height H2 of the noodle body 3 respectively are 0.6 mm, which is the best. Compared with the traditional noodles with a thicker thickness in FIGS. 1 and 2, the entire volume of the noodle of this shape has not changed, but the noodle body 3 is thinner than the traditional noodle. Therefore, the noodles of the present invention are eaten after cooked can maintain a certain bite texture (chewiness) because the volume of the noodle is not changed.

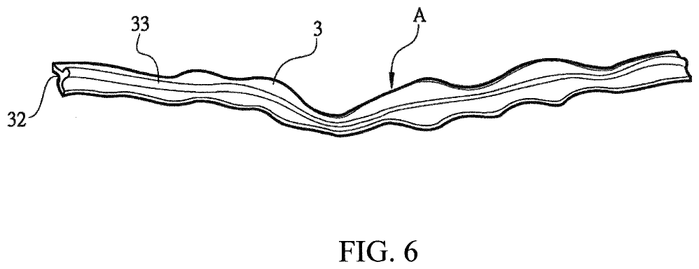

Referring to FIG. 6, the entire noodle body 3 of the quick-cooking noodle A can be curled after drying to form wrinkles 32 and wavy lines 33 to facilitate packaging and storage, and easy to take when eating.

During the quick-cooking noodle of the present invention is cooked, the noodle body 3 is cooked through from both sides inward because the both sides of the noodle body 3 will first thin). two more easily heated positions besides the multi-angle heating area formed by the wrinkles 32 and wavy lines 33, making the noodle body 3 fully cooked inward from the both sides, capable of shortening the cooking time, and avoiding the noodle body 3 fully cooked at the edges and the middle part not fully cooked, or the middle part fully cooked and the edges too soft to make the cooked noodles maintain a certain texture (chewiness), and soup or seasoning attach to the wrinkles 32 and wavy lines 33, so as to add flavor to the noodles.

Conclusively, according to the present invention, the flat noodle body is combined with the convex rib on the surface of the noodle body to form a quick-cooking noodle, allowing the cooking time of the noodles to be shortened, and the bite texture of the cooked noodles to be increased.

I claim:

1. A quick-cooking noodle structure, comprising a noodle body and at least one convex rib, wherein said noodle body is strip-shaped and flat; said convex rib is configured on one surface of said noodle body along a long side of said noodle body; a width of said convex rib is equal to a width of said noodle body on each of both sides of said convex rib, and a height of said convex rib is equal to a height of said noodle body, thereby allowing said noodle body to generate wrinkles and wavy lines when said noodle body is dried to a quick-cooking noodle, making cooking time of said quick-cooking noodle shorten, increasing cooked noodle bite texture, and further allowing soup or seasoning to attach to said wrinkles and wavy lines, so as to add flavor to said noodles.

2. The structure according to claim 1, wherein a width of said convex rib is set to 1 mm, and a width of said noodle body on each of said both sides of said convex rib 1 mm.

3. The structure according to claim 1, wherein a height said convex rib is set to 0.6 mm, and a height of said noodle body 0.6 mm.
